(19) United States
(12) Patent Application Publication
(10) Pub. No.: US 2015/0362727 A1
(43) Pub. Date: Dec. 17, 2015

(54) COMBINER ELEMENT FOR A HEAD UP DISPLAY AND HEAD UP DISPLAY

(71) Applicant: JOHNSON CONTROLS GMBH, Burscheid (DE)

(72) Inventors: Sebastien HERVY, Liancourt-Saint-Pierre (FR); Bernd LUDEWIG, Weinheim (DE); Ralf MAYER, Bolanden (DE); Jean-Christophe JOLY-VUILLEMIN, Pontoise (FR)

(21) Appl. No.: 14/761,956

(22) PCT Filed: Jan. 15, 2014
(86) PCT No.: PCT/EP2014/050646

§ 371 Date: Jul. 20, 2015

(30) Foreign Application Priority Data
Jan. 21, 2013 (EP) 13152082.7

(51) Int. Cl. G02B 27/01

(52) U.S. Cl. CPC G02B 27/01

(57) ABSTRACT

A combiner element for a head up display (HUD) system includes: a glass pane, a further glass pane, and a safety foil, the glass pane having a first main plane of extension, a first main surface and a second main surface, the second main surface being positioned opposite of the first main surface of the glass pane, the further glass pane having a second main plane of extension, a third main surface and a fourth main surface, the fourth main surface being positioned opposite of the third main surface of the further glass pane, and the safety foil being positioned between the first main plane of extension and the second main plane of extension such that the safety foil is positioned on the second main surface of the glass pane and on the third main surface of the further glass pane.

### CROSS-REFERENCE TO RELATED APPLICATIONS

This application is a U.S. National Phase application under 35 U.S.C. §371 of International Application No. PCT/EP2014/050646, filed on Jan. 15, 2014, and claims benefit to European Patent Application No. EP 13152082.7, filed on Jan. 21, 2013. The International Application was published in English on Jul. 24, 2014 as WO 2014/111393 A1 under PCT Article 21(2).

### FIELD

The present invention relates to a combiner element for a head up display (HUD), especially for a motor vehicle.

Furthermore, the present invention relates to a head up display for a motor vehicle, comprising a combiner element.

### BACKGROUND

A head up display (HUD) is an element for projecting information directly into a human's visual field.

Head up displays are commonly used for motor vehicles, where the head up displays project information towards the user of the head up display such that the information is visible for the user when looking through the windshield of the motor vehicle.

The information displayed by the head up display may be data or symbolic images indicative of various information, e.g., related to the conditions of the motor vehicle such as the velocity of the motor vehicle and/or of other parameters of the motor vehicle.

These images are presented in overlying fashion on the user's field of view so as not to interfere with the user's view of the scene behind the wind shield.

### SUMMARY

In an embodiment, the present invention provides a combiner element for a head up display (HUD) system. The combiner element comprises: a glass pane, a further glass pane, and a safety foil, the glass pane having a first main plane of extension, a first main surface and a second main surface, the second main surface being positioned opposite of the first main surface of the glass pane, the further glass pane having a second main plane of extension, a third main surface and a fourth main surface, the fourth main surface being positioned opposite of the third main surface of the further glass pane, the safety foil being positioned between the first main plane of extension and the second main plane of extension such that the safety foil is positioned on the second main surface of the glass pane and on the third main surface of the further glass pane. At least in one direction along the first and/or second main plane of extension, the safety foil and/or at least one out of the glass pane and the further glass pane is wedge-shaped.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a cross sectional representation of a first embodiment of a combiner element for a head up display according to the present invention.

FIG. 2 shows a cross sectional representation of a second embodiment of a combiner element for a head up display according to the present invention.

### DETAILED DESCRIPTION

The combiner element of the head up display is a critical component to provide reliable image, especially a collimated display image, to the user.

In some embodiments of conventional head up displays, the head up display combiner element can be positioned in at least a first and a second position by means of a kinematic module of the head up display. This advantageously allows for a stowed away positioning of the head up display, and especially the combiner element of the head up display, especially when the motor vehicle is not in use.

The head up displays tend to become larger in size because users tend to require to be provided with a larger field of view in an overlaying manner.

Therefore, also head up display combiner elements tend to become bigger and larger, especially wider so as to provide larger and/or wider and/or bigger images in overlaid manner to a user of the head up display.

This in turn adds weight to the head up display combiner element, especially in embodiments that comprise a kinematic module such as to position or move the head up display combiner element from a first position towards a second position (and vice versa) in different modes of operation of the motor vehicle.

Furthermore, the increased size and weight of typical head up display combiner elements causes stiffness and robustness problems related to the head up display combiner elements. The use of glass as material of at least a part of the combiner element possibly leads to safety concerns in case of a crash situation of the motor vehicle due to glass parts of the combiner element in case of a break or a crash of the combiner element.

In an embodiment, the present invention provides a head up display with a combiner element and especially a combiner element that avoids or at least reduces the problems associated with conventional head up display combiner elements and thereby allows to provide head up display combiner elements having a comparably high degree of robustness and stiffness, especially when used with a kinematic module to move the combiner element from a first position to a second position (and vice versa), and furthermore having excellent optical properties, especially an elimination or at least a reduction of double images, as well as a reduced weight and reduced associated costs and an increased safety level.

In a first exemplary embodiment, the present invention provides a combiner element for a head up display (HUD) system, comprising:
at least a glass pane,
at least a further glass pane, and
at least a safety foil,
the glass pane having a first main plane of extension, a first main surface and a second main surface, the second main surface being positioned opposite of the first main surface of the glass pane,
the further glass pane having a second main plane of extension, a third main surface and a fourth main surface, the fourth main surface being positioned opposite of the third main surface of the further glass pane,
the safety foil being positioned between the first main plane of extension and the second main plane of extension such that the safety foil is positioned on the second main surface of the glass pane and on the third main surface of the further glass pane,
wherein, at least in one direction along the first and/or second main plane of extension,

the safety foil
and/or

at least one out of the glass pane and the further glass pane
is provided wedge-shaped.

Thereby, it is advantageously possible to provide a sufficiently large but however stable and robust combiner element while limiting the weight and cost of the combiner element. Additionally, it is advantageously possible to increase the safety level of the combiner element, especially in case of a crash situation of the motor vehicle by avoiding parts of the combiner element travelling in the passenger compartment of the motor vehicle while in a crash situation.

In a preferred embodiment of the first embodiment of the present invention, the combiner element comprises a further safety foil, wherein the further safety foil is positioned on the first main surface of the glass pane or on the fourth main surface of the second glass pane.

Thereby, it is advantageously possible to still increase the safety level of the combiner element due to the fact that besides the safety foil the further safety foil is present to provide a protection against parts of the combiner element travelling in the passenger compartment of the motor vehicle in a crash situation.

In a second exemplary embodiment, the present invention provides a combiner element for a head up display (HUD) system, comprising:
at least a glass pane, and
at least a safety foil,
the glass pane having a first main plane of extension, a first main surface and a second main surface, the second main surface being positioned opposite of the first main surface of the glass pane,
the safety foil being positioned on the first surface of the glass pane.

Thereby, it is advantageously possible to provide a sufficiently large but however stable and robust combiner element while limiting the weight and cost of the combiner element. Additionally, it is advantageously possible to increase the safety level of the combiner element, especially in case of a crash situation of the motor vehicle by avoiding parts of the combiner element travelling in the passenger compartment of the motor vehicle while in a crash situation.

In a preferred embodiment of the second exemplary embodiment of the present invention, the combiner element comprises a further safety foil, wherein the further safety foil is positioned on the second main surface of the glass pane.

Thereby, it is advantageously possible to still increase the safety level of the combiner element due to the fact that a safety foil is present on both sides of the glass pane to provide a protection against parts of the combiner element travelling in the passenger compartment of the motor vehicle in a crash situation.

According to both the first and the second exemplary embodiment of the present invention, it is preferred that the safety foil has, along a direction perpendicular to the first main plane of extension, a varying thickness.

According to both the first and the second exemplary embodiment of the present invention, it is preferred that the further safety foil has, along a direction perpendicular to the first main plane of extension, a varying thickness.

This means that in different parts of the safety foil and/or of the further safety foil (along the first main plane of extension of the glass pane) the thickness of the safety foil and/or of the further safety foil (in a direction perpendicular to the first plane of extension) varies, e.g. in a wedge-shaped manner, in order to provide both a sufficient level of safety, especially in a crash situation of the motor vehicle, as well as good optical properties, especially an elimination or at least a reduction of double images.

According to both the first and the second exemplary embodiment of the present invention, it is preferred that the glass pane has, along a direction perpendicular to the first main plane of extension, a varying thickness.

According to both the first and the second exemplary embodiment of the present invention, it is preferred that the further glass pane has, along a direction perpendicular to the second main plane of extension, a varying thickness.

This means that in different parts of the glass pane and/or of the further glass pane (along the first/second main plane of extension of the glass pane/further glass pane) the thickness of the glass pane and/or of the further glass pane (in a direction perpendicular to the first/second plane of extension) varies, e.g. in a wedge-shaped manner, in order to provide both a sufficient level of safety, especially in a crash situation of the motor vehicle, as well as good optical properties, especially an elimination or at least a reduction of double images.

The present invention also relates—especially with respect to the first exemplary embodiment of the present invention—to a head up display comprising a combiner element, the combiner element comprising:
at least a glass pane,
at least a further glass pane, and
at least a safety foil,
the glass pane having a first main plane of extension, a first main surface and a second main surface, the second main surface being positioned opposite of the first main surface of the glass pane,
the further glass pane having a second main plane of extension, a third main surface and a fourth main surface, the fourth main surface being positioned opposite of the third main surface of the further glass pane,
the safety foil being positioned between the first main plane of extension and the second main plane of extension such that the safety foil is positioned on the second main surface of the glass pane and on the third main surface of the further glass pane,
wherein, at least in one direction along the first and/or second main plane of extension,

the safety foil
and/or

at least one out of the glass pane and the further glass pane
is provided wedge-shaped.

The present invention also relates especially with respect to the second exemplary embodiment of the present invention to a head up display comprising a combiner element, the combiner element comprising:
at least a glass pane, and
at least a safety foil,
the glass pane having a first main plane of extension, a first main surface and a second main surface, the second main surface being positioned opposite of the first main surface of the glass pane,
the safety foil being positioned on the first surface of the glass pane.

Exemplary embodiments of the present invention are depicted in the following figures and, along with further advantages and details, further clarified.

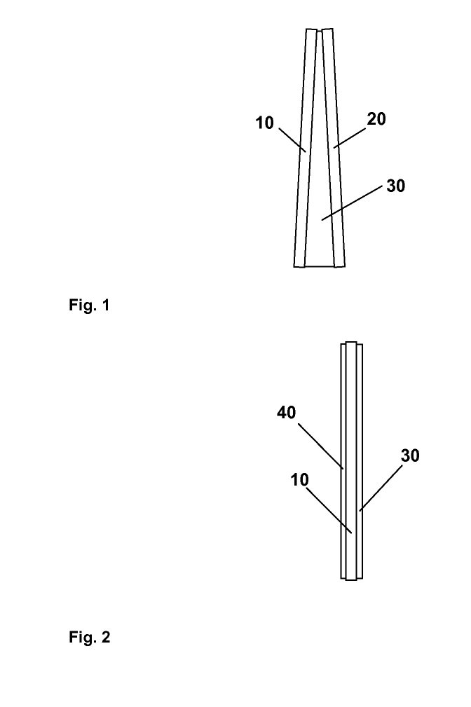

FIG. 1 shows a cross sectional representation of a first embodiment of a combiner element for a head up display according to the present invention. According to the first embodiment of the present invention, the combiner element comprises a first glass pane 10 and a second glass pane 20. The first and second glass pane 10, 20 are hereinafter also called a glass pane 10 and a further glass pane 20. The glass pane 10 has a first main plane of extension, a first main surface and a second main surface (opposite to the first main surface), which are extending perpendicularly with respect to the drawing plane and therefore are not visible in FIG. 1 due to the cross sectional representation of the combiner element. The further glass pane 20 has a second main plane of extension, a third main surface and a fourth main surface (opposite to the third main surface), which are extending perpendicularly with respect to the drawing plane and therefore are not visible in FIG. 1 due to the cross sectional representation of the combiner element.

Between the glass pane 10 and the further glass pane 20, especially between the second main surface (of the glass pane 10) and the third main surface (of the further glass pane 20), a safety foil 30 is located, wherein, at least in one direction along the first and/or second main plane of extension, the safety foil 30 and/or at least one out of the glass pane 10 and the further glass pane 20 is provided wedge-shaped, i.e. has a varying thickness (along a direction perpendicular to the first and/or second main plane of extension). In FIG. 1, only the case of a varying thickness (or wedge-shaped form) of the safety foil is represented. In a further embodiment or further embodiments (not represented in FIG. 1), the case of a varying thickness (or wedge-shaped form) of the glass pane 10 and/or of the further glass pane 20 is realized.

FIG. 2 shows a cross sectional representation of a second embodiment of a combiner element for a head up display according to the present invention. According to the second embodiment of the present invention, the combiner element comprises a glass pane 10. The glass pane 10 has a first main plane of extension, a first main surface and a second main surface (opposite to the first main surface), which are extending perpendicularly with respect to the drawing plane and therefore are not visible in FIG. 2 due to the cross sectional representation of the combiner element. In FIG. 2 and in a variant of the second embodiment of the present invention, a safety foil 30 is positioned on the first main surface of the glass pane 10 and a further safety foil 40 is positioned on the second main surface of the glass pane 10. Alternatively to a combiner element having the glass pane 10 and two safety foils 30, 40 (as depicted in FIG. 2), a variant (not represented in FIG. 2) of the second embodiment may comprise only one safety foil 30 (on one of the main surfaces). In both variants of the second embodiment of the present invention, it is possible and preferred that the glass pane 10 and/or at least one out of the safety foil 30 or the further safety foil 40 is provided wedge-shaped (not represented in FIG. 2), i.e. has a varying thickness (along a direction perpendicular to the first main plane of extension).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 glass pane
20 further glass pane
30 safety foil
40 further safety foil

1. A combiner element for a head up display (HUD) system, comprising:
a glass pane,
a further glass pane, and
a safety foil,
the glass pane having a first main plane of extension, a first main surface and a second main surface, the second main surface being positioned opposite of the first main surface of the glass pane,
the further glass pane having a second main plane of extension, a third main surface and a fourth main surface, the fourth main surface being positioned opposite of the third main surface of the further glass pane,
the safety foil being positioned between the first main plane of extension and the second main plane of extension such that the safety foil is positioned on the second main surface of the glass pane and on the third main surface of the further glass pane,
wherein, at least in one direction along the first and/or second main plane of extension, the safety foil and/or at least one out of the glass pane and the further glass pane is wedge-shaped.

2. The combiner element of claim 1, wherein the combiner element comprises a further safety foil, wherein the further safety foil is positioned on the first main surface of the glass pane or on the fourth main surface of the second glass pane.

3. A combiner element for a head up display (HUD) system, comprising:
a glass pane, and
at least a safety foil,
the glass pane having a first main plane of extension, a first main surface and a second main surface, the second main surface being positioned opposite of the first main surface of the glass pane,
the safety foil being positioned on the first surface of the glass pane.

4. The combiner element of claim 3, wherein the combiner element comprises a further safety foil, wherein the further safety foil is positioned on the second main surface of the glass pane.

5. The combiner element of claim 1, wherein the safety foil has, along a direction perpendicular to the first main plane of extension, a varying thickness.

6. The combiner element of claim 2, wherein the further safety foil has, along a direction perpendicular to the first main plane of extension, a varying thickness.

7. The combiner element of claim 1, wherein the glass pane has, along a direction perpendicular to the first main plane of extension, a varying thickness.

8. The combiner element of claim 1, wherein the further glass pane has, along a direction perpendicular to the second main plane of extension, a varying thickness.

9. A head up display (HUD) system, comprising a the combiner element of claim 1.

10. A head up display (HUD) system, comprising the combiner element of claim 3.

11. The combiner element of claim 3, wherein the safety foil has, along a direction perpendicular to the first main plane of extension, a varying thickness.

12. The combiner element of claim 4, wherein the further safety foil has, along a direction perpendicular to the first main plane of extension, a varying thickness.

13. The combiner element of claim 3, wherein the glass pane has, along a direction perpendicular to the first main plane of extension, a varying thickness.
